(19) United States
(12) Patent Application Publication
(10) Pub. No.: US 2016/0171449 A1
(43) Pub. Date: Jun. 16, 2016

(54) Apprenticeship Planning and Management System

(71) Applicant: Tanja Baeck, Wiesloch (DE)

(72) Inventor: Tanja Baeck, Wiesloch (DE)

(21) Appl. No.: 14/567,276

(22) Filed: Dec. 11, 2014

(51) Int. Cl. G06Q 10/10

(52) U.S. Cl. CPC G06Q 10/1093

(57) ABSTRACT

An apprenticeship planning and management system is disclosed. In various embodiments, the apprenticeship planning and management system can include: (1) a central planning module that enables a training supervisor of a company to assign apprentices to departments and view company-wide apprentice schedules based on the departmental assignments; (2) a department-level view module that enables an administrator of a particular company department to view schedules and detailed information for apprentices that have been assigned to that department; and (3) an apprentice-level view module that enables each apprentice to view their individual work/school schedules. In this manner, the system can facilitate planning, administration, and information exchange with respect to the company's apprenticeships.

### BACKGROUND

Apprenticeship refers to the practice of training a new generation of practitioners (known as apprentices) in a trade or profession via on-the-job training and mentoring. Although first developed during the Middle Ages, apprenticeship schemes are still widely used today in countries such as Germany, Australia, Switzerland, Austria, France, and others. For example, apprenticeship is an integral part of Germany's dual education system. Under this dual system, students spend 50-70% of their time over a period of approximately three years working as an apprentice for a company in a particular trade/profession, and spend the remainder of their time in formal education. After completing their apprenticeships, the former apprentices are entitled to obtain employment in their fields of expertise. In Germany, there are currently 342 recognized trades (“Ausbildungsberufe”) in which an apprenticeship can be completed. These trades include craft-based professions, such as baking, tailoring, carpentry, etc., as well as business-oriented professions, such as finance, engineering, industrial management, etc.

One challenge for German companies (and companies in other countries where apprenticeship is prevalent) is managing information regarding the apprentices they hire for their various business units/departments. For instance, a large German company like Siemens or SAP may employ thousands of apprentices at a given time, spread across tens or hundreds of departments, which makes apprenticeship management a daunting task. Many companies have employee/human resource (HR) management systems that enable generic HR functions such as time-off/attendance, payroll, recruiting, learning management, and so on. However, existing employee/HR management systems are not designed to track and manage apprenticeship-specific data. Accordingly, such existing systems cannot be directly used by company stakeholders to plan, administer, and/or view information regarding the company's apprenticeships.

### SUMMARY

An apprenticeship planning and management system is disclosed. In various embodiments, the apprenticeship planning and management system can include: (1) a central planning module that enables a training supervisor of a company to assign apprentices to departments and view company-wide apprentice schedules based on the departmental assignments; (2) a department-level view module that enables an administrator of a particular company department to view schedules and detailed information for apprentices that have been assigned to that department; and (3) an apprentice-level view module that enables each apprentice to view their individual work/school schedules. In this manner, the system can facilitate planning, administration, and information exchange with respect to the company's apprenticeships.

### BRIEF DESCRIPTION OF THE DRAWINGS

FIG. 1 depicts a system environment that includes an apprenticeship planning and management system according to an embodiment.

FIG. 2 depicts a flowchart executable by a central planning module for enabling a user (e.g., training supervisor) to carry out company-wide apprenticeship planning/management according to an embodiment.

FIG. 3 depicts a calendar-based user interface generated by the central planning module according to an embodiment.

FIG. 4 depicts a flowchart for importing events into the calendar-based user interface of FIG. 3 according to an embodiment.

FIG. 5 depicts a flowchart for validating a departmental assignment for an apprentice according to an embodiment.

FIG. 6 depicts a flowchart executable by a department-level view module for enabling a user (e.g., department administrator) to view information regarding the apprentices assigned to a specific department according to an embodiment.

FIG. 7 depicts a calendar-based user interface generated by the department-level view module according to an embodiment.

FIG. 8 depicts a flowchart executable by an apprentice-level view module for enabling an apprentice to view his/her work and school schedules according to an embodiment.

FIG. 9 depicts a calendar-based user interface generated by the apprentice-level view module according to an embodiment.

FIG. 10 depicts a computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

Embodiments of the present disclosure provide a system that can be implemented by a company (or a service provider contracted to provide software services to the company) for planning and managing the company's apprenticeships. At a high level, the system can include a central planning module, a department-level view module, and an apprentice-level view module. The central planning module can enable a training supervisor of the company to, e.g., define apprenticeship-specific data for apprentices hired by the company, define apprenticeship-specific data for departments/sub-departments within the company, assign apprentices to departments/sub-departments, and view calendar-based schedules for the apprentices based on their school periods, school vacation, department work periods, internal training events, requested time-off, and other events. In this way, the central planning module can facilitate the creation of per-department apprenticeship plans, as well as allow the training supervisor to visualize where each apprentice will be (and when) based on their departmental assignments.

The department-level view module can enable a department administrator (or other department user) to view the schedules of all apprentices that have been assigned to that department (and its constituent sub-departments) via the central planning module. For example, the department-level view module can generate a calendar-based UI that illustrates the time slots during which each apprentice will be working for the department, as well as other events that affect the availability of the apprentice (e.g., school periods, school vacation, internal training events, time-off, etc.). The UI can also display detailed information about each apprentice, such as their contact information, school, learning/training history, skills, and so on. Accordingly, the department-level view module can provide the department administrator with relevant information for planning and preparing effectively for the department's incoming group of assigned apprentices.

Finally, the apprentice-level view module can enable an apprentice that is employed with the company to view his/her individual work and school schedules. For example, the apprentice-level view module can generate a calendar-based UI that displays schedule information similar to the information presented via the central planning and department-level view modules (e.g., work times, school periods, school vacation, internal training events, time-off, etc.), but is specific to a single apprentice. In addition, the apprentice-level view module can provide the apprentice with information regarding his/her assigned department (e.g., departmental contact, office location, etc.). Thus, with this module, the apprentice can easily keep track of where he/she needs to be on a daily basis, and who to get in touch with if he/she has questions regarding the apprenticeship.

In certain embodiments, the apprenticeship planning and management system described above can be integrated with the company's existing employee/HR management system. For instance, upon receiving apprenticeship-specific data for apprentices or departments within the company, the central planning module can store this data as part of existing employee and department data objects/tables maintained by the company's employee/HR management system, rather than as new data objects or tables. This avoids the need to replicate employee/HR data in backend storage for apprenticeship management purposes.

In addition, the apprenticeship planning and management system can automatically pull data from the existing employee/HR management system as needed to provide additional contextual information to the various users of the central planning, department-level view, and apprentice-level view modules. For example, in one embodiment, the apprenticeship planning and management system can automatically pull information regarding time-off requested by each apprentice from an existing time-off/attendance module of the employee/HR management system. This time-off information can then be reflected in the calendar-based schedules generated for the training supervisor, department administrators, and apprentices. In another embodiment, the apprenticeship planning and management system can automatically pull learning/training data for each apprentice from an existing learning management module of the employee/HR management system, and can present this data in the department-level apprentice detail UIs.

These and other aspects of the present disclosure are described in further detail in the sections that follow.

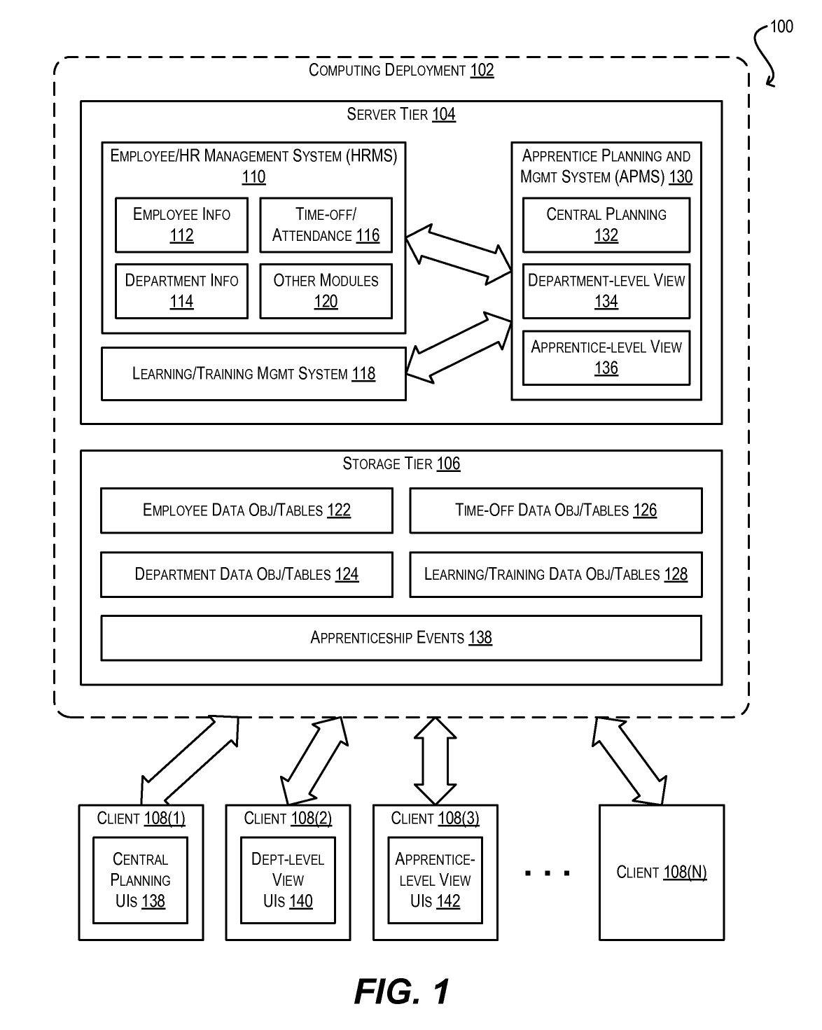

FIG. 1 depicts a system environment 100 that implements an apprenticeship planning and management system according to an embodiment. As shown, system environment 100 includes a computing deployment 102 that comprises a server tier 104 and a storage tier 106. Computing deployment 102 provides software services to employees of a particular company, such as users operating client devices 108(1)-108(N). In one embodiment, computing deployment 102 can be maintained by an internal information technology (IT) organization of the company. In other embodiments, computing deployment 102 can be maintained by an external service provider, such as a cloud service provider, that has agreed to host software services on behalf of the company.

Server tier 104, which can be implemented using one or physical computer systems, is configured to run (among other things) an employee/HR management system (HRMS) 110 for the company. An example of such an HRMS is SAP's Employee Central software suite. As shown, HRMS 110 includes an employee info module 112, a department info module 114, a time-off/attendance module 116, and other modules 120. Employee info and department info modules 112 and 114 can enable users of HRMS 110 to enter/maintain information regarding the employees and departments/sub-departments of the company respectively. Time-off/attendance module 116 can enable employees of the company to request and receive approval for time-off/vacation days. And other modules 120 can provide further features that are commonly implemented in conventional HRMS s, like payroll management, benefits management, employee performance tracking, and so on.

Server tier 104 further includes a learning/training management system 118 that can facilitate various aspects of employee training, such as providing employee access to online learning content and/or specific training curricula, tracking employee learning/training history, and so on. An example of such a system is the Learning Management System of the SuccessFactors' BizX Suite.

Storage tier 106 of computing deployment 102, which can be implemented using one or more physical storage components (e.g., dedicated storage arrays, commodity hard/flash disks, etc.), is configured to store persistent data on behalf of HRMS 110. For example, in FIG. 1, storage tier 106 stores employee data objects/tables 122 associated with employee info module 112, department data objects/tables 124 associated with department info module 114, time-off data objects/tables 126 associated with time-off/attendance module 116, and learning/training data objects/tables 128 associated with learning/training management system 118.

As noted in the Background section, one problem with existing HRMS implementations is that they are not designed to facilitate apprenticeship management. For example, assume that the company associated with computing deployment 102 is a German company (or a company in another country where apprenticeship is widely used) with a large number of apprentices spread across numerous departments. In this scenario, with existing HRMS solutions, there would be no way for the various stakeholders in the apprenticeship process to directly use the HRMS in order to, e.g., assign apprentices to departments, view apprentice information and schedules, and so on.

To address these and other similar issues, server tier 104 of FIG. 1 includes an apprenticeship planning and management system (APMS) 130 (communicatively coupled with HRMS 110 and learning/training management system 118) that comprises a central planning module 132, a department-level view module 134, and an apprentice-level view module 136. As described in further detail below, these modules of APMS 130 can perform server-side processing and generate UIs for display on client devices 108(1)-108(N) (e.g., central planning UIs 138, department-level view UIs 140, and apprentice-level view UIs 142 shown within client devices 108(1), 108(2), and 108(3) respectively) that facilitate the planning, administration, and dissemination of information regarding the company's apprenticeships. For example, APMS 130 can capture and display apprenticeship events, such as group events and training, departmental work periods, offsite events, and the like (shown via reference numeral 138 in storage tier 106) via UIs 138-142. APMS 130 can also capture and display apprenticeship-specific employee and department data (stored as, e.g., part of employee data objects/tables 122 and department data objects/tables 124). Thus, APMS 130 can improve information access and streamline apprenticeship management for all of the company stakeholders/participants involved in the process (e.g., training supervisors, department administrators, and the apprentices themselves).

It should be appreciated that system environment 100 is illustrative and not intended to limit the embodiments discussed herein. For example, while APMS 130 is shown as being a separate component from HRMS 110, in some embodiments APMS 130 may be directly integrated into HRMS 110. In these embodiments, central planning module 132, department-level view module 134, and apprentice-level view module 136 can be created as additional modules of HRMS 110 (similar to modules 112-120).

Further, it should be appreciated that the specific technologies used to implement the various entities/modules shown in system environment 100 may vary. For instance, in one embodiment, client-side UIs 138-142 generated by modules 132-136 of APMS 130 can be implemented as mobile applications designed to run on a smartphone or other mobile device (e.g., a tablet or smartwatch). Alternatively or in addition, client-side UIs 138-142 can be implemented as web-based interfaces that are designed to run within a conventional web browser. One of ordinary skill in the art will recognize many variations, modifications, and alternatives.

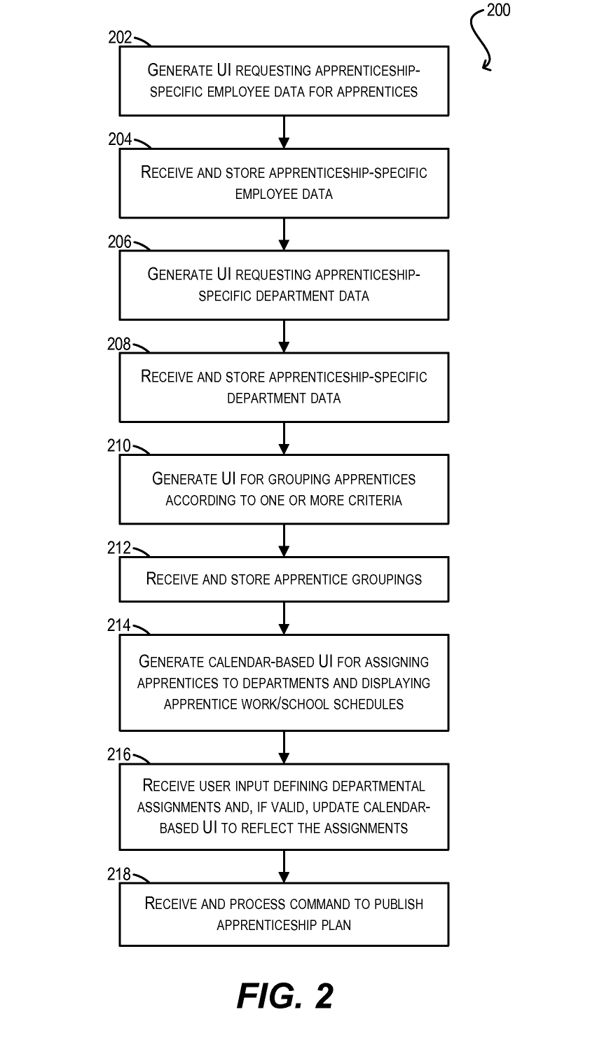

FIG. 2 depicts a flowchart 200 of a process that may be performed by central planning module 132 of APMS 130 for enabling a training supervisor of the company (operating, e.g., client device 108(1) shown in FIG. 1) to perform apprenticeship planning/administration functions according to an embodiment. Starting with block 202, central planning module 132 can generate a UI requesting apprenticeship-specific employee data for apprentices that have been hired by the company. This apprenticeship-specific employee data can include, e.g., apprenticeship year, trade/profession, class year, and school.

At block 204, central planning module 132 can receive the requested apprenticeship-specific employee data and can store the data in storage tier 106. In a particular embodiment, this data can be stored as part of one or more existing employee data objects/tables (i.e., 122) maintained by HRMS 110, thereby avoiding the need to create duplicate data records for each apprentice.

At block 206, central planning module 132 can generate a UI requesting apprenticeship-specific department data for each of the company departments participating in the apprenticeship program. This apprenticeship-specific department data can include, e.g., contact information for the apprentices of the department, off-periods for the department, preferences, and maximum capacity (i.e., the maximum number of apprentices the department can train).

At block 208, central planning module 132 can receive the requested apprenticeship-specific department data and can store the data in storage tier 106. Like the apprenticeship-specific employee data, the apprenticeship-specific department data can be stored as part of one or more existing department data objects/tables (i.e., 124) maintained by HRMS 110, thereby avoiding the need to create duplicate data records for each department.

At block 210, central planning module 132 can generate a UI for grouping the apprentices according to one or more criteria. For example, the apprentices can be grouped by trade/profession, apprenticeship year, class year, location, school, etc. At block 212, central planning module 132 can receive the groupings defined by the training supervisor and store the groupings in storage tier 106.

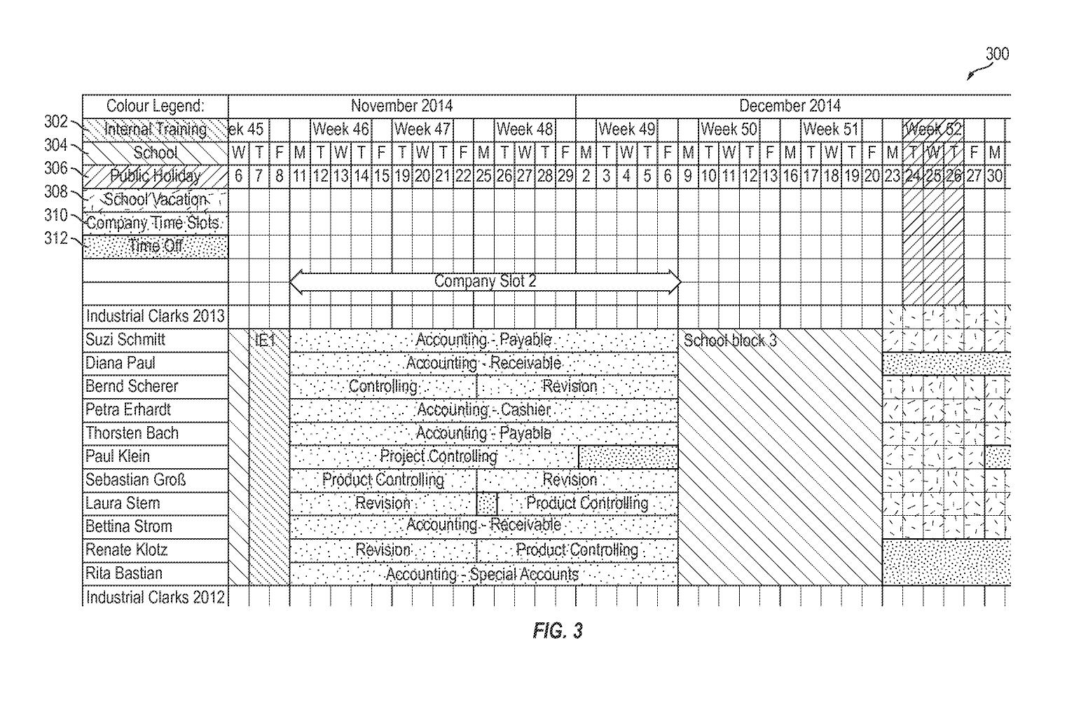

Then, at block 214, central planning module 132 can generate a calendar-based UI for assigning apprentices to departments (either on a per-apprentice or per-group basis) and viewing the schedules for each apprentice according to their departmental assignments. For instance, FIG. 3 depicts an example of such a calendar-based UI 300 according to an embodiment. As shown in FIG. 3, UI 300 depicts apprentices (grouped according to the groupings defined at block 212) along the Y-axis, a calendar timeline (e.g., days/weeks/months) along the X-axis, and calendar events for the apprentices within the intersecting cells. The training supervisor can assign apprentices to specific departments or sub-departments in UI 300 by, e.g., dragging-and-dropping department/sub-department indicators into cells corresponding to the apprentices for desired periods of time. Central planning module 132 can receive these user inputs and, if the assignments are valid, can update UI 300 to include new calendar events (specifically, departmental work periods) that reflect the newly-defined assignments (block 216). For example, in FIG. 3, apprentice “Susie Schmitt” is shown as being assigned to the “Accounting-Payable” department for the work period spanning weeks 46-49.

As part of generating calendar-based UI 300 at block 214, central planning module 132 can automatically populate the UI with events that are relevant to the apprentices. The events can include, e.g., internal training, school periods, holidays, school vacation, company work slots, and time-off (shown via legend elements 302, 304, 306, 308, 310, and 312 in FIG. 3).

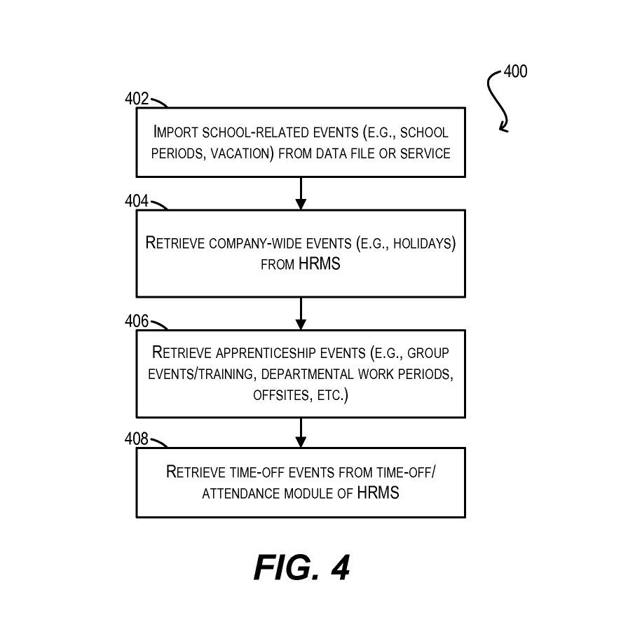

FIG. 4 depicts a flowchart 400 for performing this processing according to an embodiment. At block 402, central planning module 132 can import school-related events for each apprentice or apprentice group, such as school periods and vacation, from a data file or service made available by the apprentices' schools. At block 404, central planning module 132 can retrieve company-wide events (e.g., holidays) from HRMS 110. At block 406, central planning module 132 can retrieve apprenticeship-specific events (e.g., group events, internal (departmental or learning) training, departmental work periods, offsites, etc.) from one or more modules of HRMS 110 and/or learning/training management system 118. And at block 408, central planning module 132 can retrieve time-off events from data objects/tables 126 associated with time-off/attendance module 116, thereby capturing the time-off days requested by the apprentices via module 126. In a particular embodiment, the time-off events shown in UI 300 can indicate the current status of each request (e.g., requested or approved).

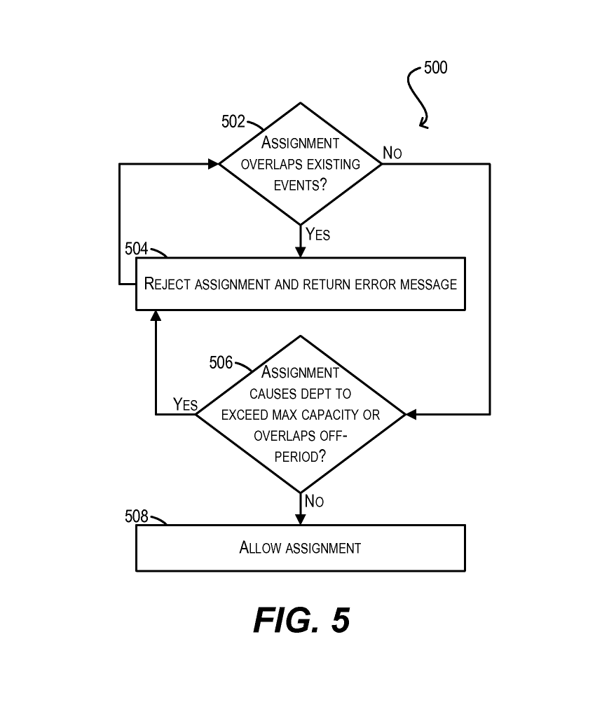

Further, as part of updating calendar-based UI 300 at block 216 of FIG. 2, central planning module 132 can validate whether the departmental assignments entered by the training supervisor are allowed. FIG. 5 depicts a flowchart 500 for performing this validation according to an embodiment. At block 502, central planning module 132 can check whether a departmental assignment for a given apprentice overlaps one or more other existing events for the apprentice shown in the calendar. If so, central planning module 132 can reject the assignment and return an appropriate error message to the training supervisor (block 504). The training supervisor can then attempt to revise the assignment and flowchart 500 can loop back to block 502.

If the departmental assignment does not overlap any existing events, central planning module 132 can check whether the assignment causes the department to exceed its maximum capacity or overlaps a department off-period (as defined by the training supervisor at block 206 of FIG. 2) (block 506). If so, central planning module 132 can reject the assignment and return an appropriate error message to the training supervisor as above (block 504).

Otherwise, central planning module 132 can allow the assignment (block 508) and flowchart 500 can end.

Returning to FIG. 2, once the training supervisor has completed assigning apprentices to departments via block 216, the training supervisor can optionally reconfigure the UI according to different views (e.g., per apprentice, per department, per apprentice group, etc.) in order to gain a better understanding of the apprentices' schedules (not shown). Finally, at block 218 of FIG. 2, central planning module 132 can receive and process a command from the training supervisor for publishing the assignments (collectively referred to as an “apprenticeship plan”). In this manner, the assignments and associated schedules can be made viewable by the other stakeholders/participants in the program (e.g., department administrators and apprentices).

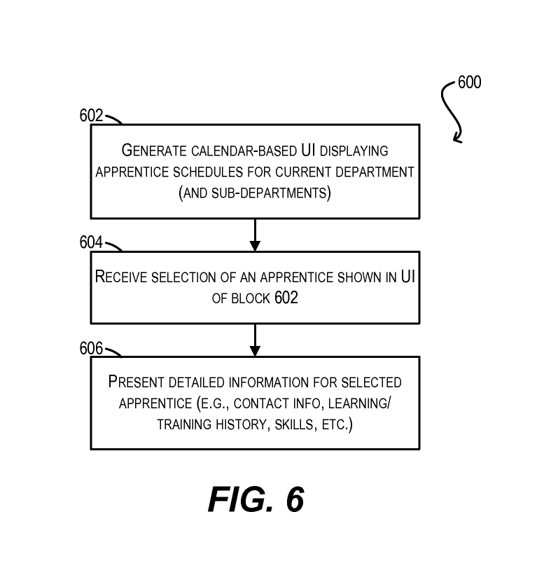

FIG. 6 depicts a flowchart 600 of a process that may be performed by department-level view module 134 of APMS 130 for enabling a department administrator (operating, e.g., client device 108(2) shown in FIG. 1) to view information regarding the apprentices assigned to his/her department according to an embodiment. Flowchart 600 assumes that the training supervisor has published an apprenticeship plan for the company per block 218 of FIG. 2.

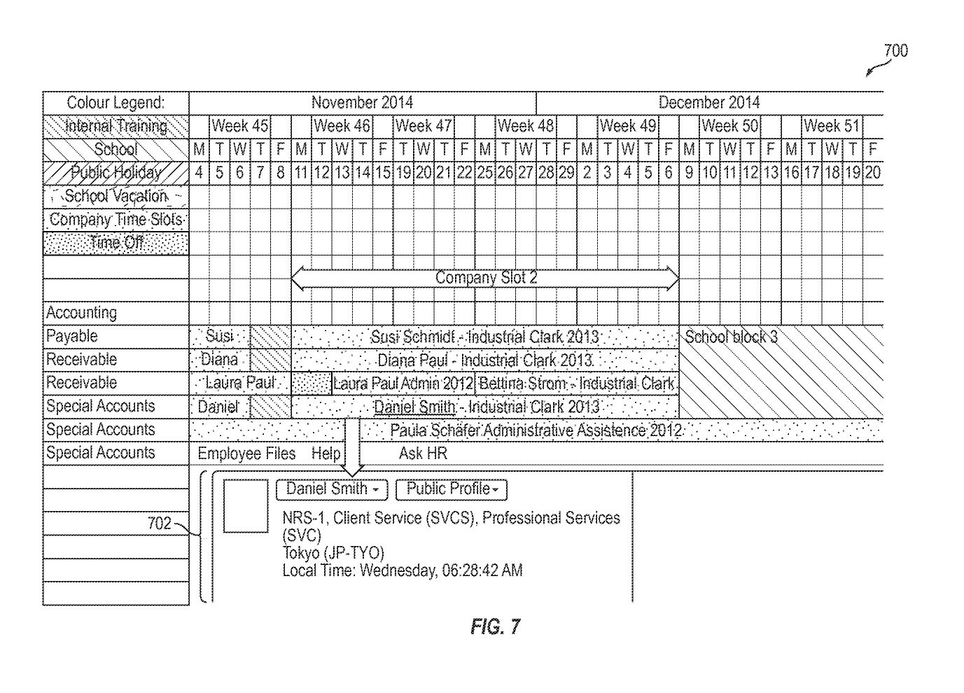

Starting with block 602, department-level view module 134 can generate a calendar-based UI displaying the schedules for the apprentices assigned to the administrator's department. FIG. 7 depicts an example of such a calendar-based UI 700 according to an embodiment. As can be seen, UI 700 is similar to UI 300 of FIG. 3, but depicts a particular department (and constituent sub-departments) along the Y-axis, and the apprentices assigned to the sub-departments in the intersecting cells. Thus, with UI 700, the department administrator can easily identify which apprentices will be working for which sub-departments, and for how long.

UI 700 also depicts the various school and work-related events for the apprentices shown in UI 300, such as school periods, school vacation, holidays, internal training, work periods, and requested time-off. Department-level view module 134 can automatically pull information for these events from the same sources as central planning module 132.

In certain embodiments, department-level view module 134 can receive a selection of a particular apprentice in UI 700 from the department administrator (block 604). For instance, the department administrator can hover (using, e.g., a mouse) over the apprentice's name, or click on the apprentice name. In response, department-level view module 134 can present detailed information regarding the selected apprentice, such as his/her contact information, learning/training history, skills, and apprenticeship-specific information entered by the training administrator via the central planning UIs (e.g., apprenticeship year, school, class year, etc.) (block 606). An example of this detailed information is shown in UI 700 via window 702. In this manner, the department administrator can get a better sense of the skills and knowledge of each incoming apprentice, and thereby plan the apprentice's training regime appropriately. In a particular embodiment, department-level view module 134 can import the apprentice detail information shown in window 702 from various existing data objects/tables maintained by HRMS 110, such as employee data objects/tables 122 and learning/training data objects/tables 128.

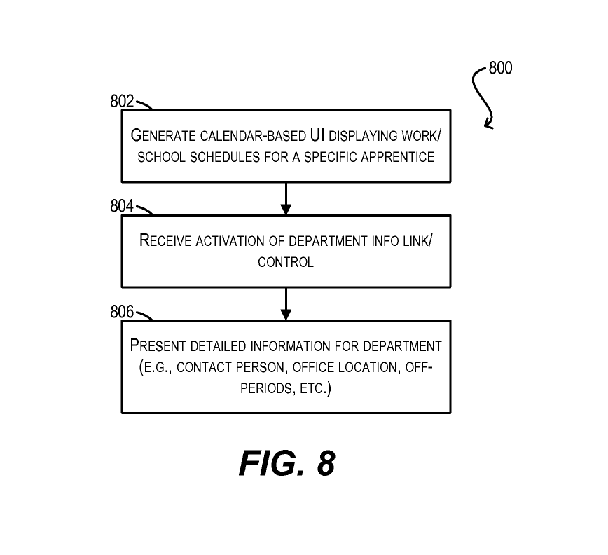

FIG. 8 depicts a flowchart 800 of a process that may be performed by apprentice-level view module 136 of APMS 130 for enabling an apprentice (operating, e.g., client device 108(3) shown in FIG. 1) to view information regarding his/her apprenticeship according to an embodiment Like flowchart 600, flowchart 800 assumes that the training supervisor has published an apprenticeship plan for the company per block 218 of FIG. 2.

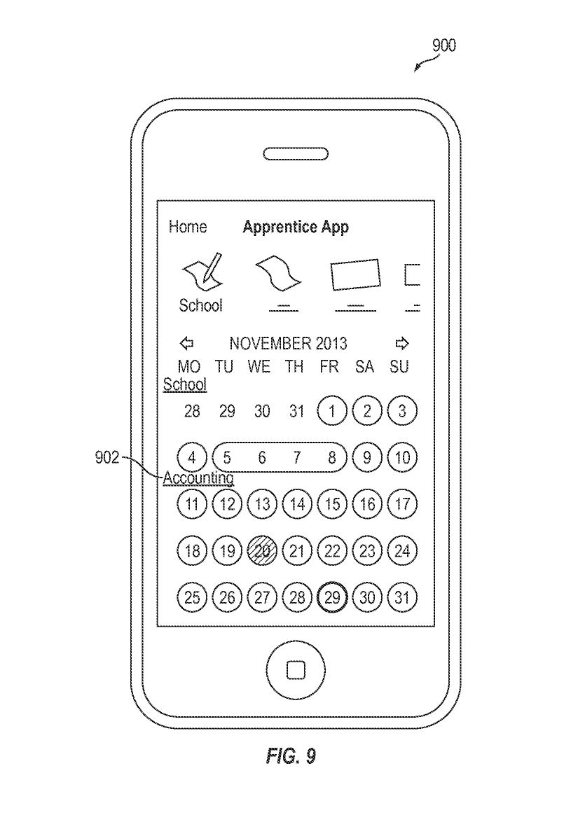

At block 802, apprentice-level view module 136 can generate a calendar-based UI that displays the apprentice's work and school schedule, as defined by the departmental assignment(s) made by the training supervisor via the central planning UIs. FIG. 9 depicts an example of such a calendar-based UI 900 according to an embodiment Like UIs 300 and 700, UI 900 shows various calendar events relevant to the apprentice, such as school periods, school vacation, work periods, internal training events, and requested time-off. Apprentice-level view module 136 can automatically pull information for these events from the same sources as central planning module 132 and department-level view module 134. However, unlike UIs 300 and 700, UI 900 is intended to provide a single apprentice with a personalized view of his/her appointments and commitments, rather than a company-wide or department-wide view. Thus, UI 900 does not display events that are specific to other apprentices in the same company or department.

In the particular example of FIG. 9, calendar-based UI 900 is shown as being implemented as a mobile application running on a smartphone. However, in alternative embodiments, calendar-based UI 900 can be implemented as, e.g., a web-based interface.

In some embodiments, the UI generated at block 802 of flowchart 800 can include a link or control that enables access to information regarding the department the apprentice has been assigned to work for. For instance, in FIG. 9, UI 900 includes an “Accounting” link 902. Upon receiving an activation of this link or control (block 804), apprentice-level view module 136 can present appropriate department information to the apprentice, such as the department contact person, office location, off-periods, and so on (block 806). In this way, the apprentice can easily figure out where he/she should be (and when), as well as who to contact if he/she has questions about the apprenticeship, via a single, unified UI.

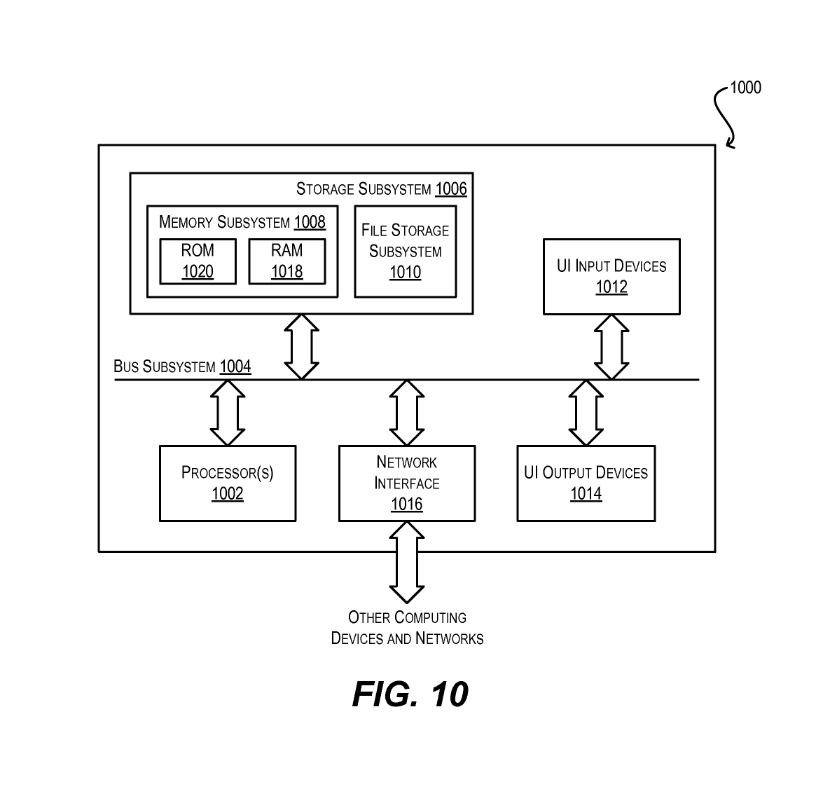

FIG. 10 depicts an exemplary computer system 1000 according to an embodiment. Computer system 1000 can be used to implement the various devices/systems described in the foregoing disclosure, such as the servers of server tier 104 and/or client devices 108(1)-108(N) of FIG. 1. As shown, computer system 1000 includes one or more processors 1002 that communicate with a number of peripheral devices via a bus subsystem 1004. These peripheral devices include a storage subsystem 1006 (comprising a memory subsystem 1008 and a file storage subsystem 1010), user interface input devices 1012, user interface output devices 1014, and a network interface subsystem 1016.

Bus subsystem 1004 can provide a mechanism for letting the various components and subsystems of computer system 1000 communicate with each other as intended. Although bus subsystem 1004 is shown schematically as a single bus, alternative embodiments of the bus subsystem can utilize multiple buses.

Network interface subsystem 1016 can serve as an interface for communicating data between computer system 1000 and other computing devices or networks. Embodiments of network interface subsystem 1016 can include wired (e.g., coaxial, twisted pair, or fiber optic Ethernet) and/or wireless (e.g., Wi-Fi, cellular, Bluetooth, etc.) interfaces.

User interface input devices 1012 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 1000.

User interface output devices 1014 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 1000.

Storage subsystem 1006 includes a memory subsystem 1008 and a file/disk storage subsystem 1010. Subsystems 1008 and 1010 represent non-transitory computer-readable storage media that can store program code and/or data that provide the functionality of various embodiments described herein.

Memory subsystem 1008 can include a number of memories including a main random access memory (RAM) 1018 for storage of instructions and data during program execution and a read-only memory (ROM) 1020 in which fixed instructions are stored. File storage subsystem 1010 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1000 is illustrative and not intended to limit embodiments of the present invention. Many other configurations having more or fewer components than computer system 1000 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
generating, by a computer system, a first user interface (UI) displaying a plurality of apprentices for a company and calendar events relevant to the plurality of apprentices, the calendar events including internal training events, school periods, school vacation, company holidays, and departmental work periods;
receiving, by the computer system, user input defining an assignment of an apprentice in the plurality of apprentices to a department of the company; and
updating, by the computer system, the first UI to include a departmental work period for the apprentice reflecting the assignment.

2. The method of claim 1 wherein the plurality of apprentices are displayed along a first axis of the first UI, wherein a calendar timeline is displayed along a second axis of the first UI, and wherein the calendar events are displayed at intersecting cells of the first axis and the second axis.

3. The method of claim 1 wherein the plurality of apprentices are grouped in the first UI according to one or more groupings.

4. The method of claim 3 wherein the one or more groupings are based on apprenticeship year, class year, or trade/profession.

5. The method of claim 1 wherein the school periods and school vacation are automatically imported from a data file or service associated with the apprentices' schools.

6. The method of claim 1 wherein the company holidays are automatically imported from one or more modules of a human resources management system used by the company, and wherein one or more of the internal training events are automatically retrieved from a learning/training management system used by the company.

7. The method of claim 1 further comprising:
generating a second UI requesting apprenticeship-specific employee data for the plurality of apprentices;
receiving user input identifying the apprenticeship-specific employee data; and
storing the apprenticeship-specific employee data as part of one or more employee data objects or tables associated with a human resources management system used by the company.

8. The method of claim 7 wherein the apprenticeship-specific employee data include apprenticeship year, school year, and trade/profession.

9. The method of claim 1 further comprising:
generating a second UI requesting apprenticeship-specific department data for a plurality of departments of the company;
receiving user input identifying the apprenticeship-specific department data; and
storing the apprenticeship-specific department data as part of one or more department data objects or tables associated with a human resources management system used by the company.

10. The method of claim 9 wherein the apprenticeship-specific department data includes departmental contact information for apprentices, department off-periods, apprentice preferences, and maximum capacity.

11. The method of claim 1 further comprising validating the assignment prior to updating the first UI, the validating comprising:
determining whether the assignment overlaps any existing calendar events for the apprentice; and
if the assignment does not overlap any existing calendar events for the apprentice, determining whether the assignment overlaps an off-period for the department or causes the department to exceed its maximum capacity.

12. The method of claim 1 wherein the calendar events further include time-off days requested by the plurality of apprentices.

13. The method of claim 12 wherein the time-off days are automatically retrieved from a time-off/attendance module of a human resources management system used by the company.

14. The method of claim 1 further comprising:
generating a second UI displaying a subset of the plurality of apprentices assigned to a particular department of the company and calendar events relevant to the subset, the calendar events including internal training events, school periods, school vacation, company holidays, and work periods for the particular department.

15. The method of claim 14 wherein each work period includes a name of an apprentice in the subset associated with the work period.

16. The method of claim 15 wherein, upon receiving a user selection of an apprentice name, displaying detailed information regarding the apprentice, the detailed information including contact information, learning/training history, and skills.

17. The method of claim 16 wherein the learning/training history and skills are automatically retrieved from a learning/training management system used by the company.

18. The method of claim 1 further comprising:
generating a second UI displaying calendar events for a single apprentice in the plurality of apprentices, the calendar events including internal training events, school periods, school vacation, company holidays, and departmental work periods specific to the single apprentice.

19. A non-transitory computer readable storage medium having stored thereon program code executable by a processor, the program code comprising:
code that causes the processor to generate a first UI displaying a plurality of apprentices for a company and a first set of calendar events relevant to the plurality of apprentices, the first set of calendar events including internal training events, school periods, school vacation, company holidays, and departmental work periods for the plurality of apprentices;
code that causes the processor to generate a second UI displaying a subset of the plurality of apprentices assigned to a particular department of the company and a second set of calendar events relevant to the subset, the second set of calendar events including internal training events, school periods, school vacation, company holidays, and work periods for the particular department; and
code that causes the processor to generate a third UI displaying a third set of calendar events for a single apprentice in the plurality of apprentices, the third set of calendar events including internal training events, school periods, school vacation, company holidays, and departmental work periods specific to the single apprentice.

20. A computer system comprising:
a processor;
a memory; and
a non-transitory computer readable storage medium having stored thereon program code that, when executed by the processor, causes the processor to:
generate a first UI requesting apprenticeship-specific employee data for a plurality of apprentices of a company;
receive user input identifying the apprenticeship-specific employee data;
store the apprenticeship-specific employee data as part of one or more employee data objects or tables associated with a human resources management system used by the company;
generate a second UI requesting apprenticeship-specific department data for a plurality of departments of the company;
receive user input identifying the apprenticeship-specific department data;
store the apprenticeship-specific department data as part of one or more department data objects or tables associated with the human resources management system;
store apprenticeship events, the apprenticeship events including internal training events and departmental work periods;
generate a third UI displaying the plurality of apprentices along a first axis, a calendar timeline along a second axis, and calendar events relevant to the plurality of apprentices at intersecting cells of the first axis and the second axis, the calendar events including the apprenticeship events, school periods, school vacation, and company holidays;
receive user input defining an assignment of an apprentice in the plurality of apprentices to a department in the plurality of departments;
validate the assignment based on the apprenticeship-specific department data; and
if the validation is successful, update the third UI to include a departmental work period for the apprentice reflecting the assignment.
